(19) United States
(12) Patent Application Publication
(10) Pub. No.: US 2006/0086541 A1
(43) Pub. Date: Apr. 27, 2006

(54) Baggage weight monitoring and theft protection

(76) Inventors: Firdous Khan, Vadodara (IN); Raymond Shah, Zurich (CH)

Correspondence Address: RAYMOND SHAH, FERDINAND HODLER - STR. 46, ZURICH, 8049, CH

(21) Appl. No.: 10/973,670

(22) Filed: Oct. 26, 2004

(51) Int. Cl. G01G 19/58; G01G 23/18; B65D 85/18

(52) U.S. Cl. 177/45; 177/245; 206/278

(57) ABSTRACT

As weight restrictions become more stringent, air, train and bus passengers are being faced with the increasing cost of excess baggage weight. The proposed system makes use of transducers built into the bag or its handle both for weight monitoring and for theft protection. In the weight monitoring mode, designed for use during packing, an excess weight alarm is triggered when a preset maximum value is exceeded. In the theft protection mode, the transducer signal triggers an alarm as soon as the bag is picked up, thus giving early warning of possible theft. In this mode the signal is preferably transmitted to an external device such as a cellular phone for remote audible and/or visible indication. Because the circuits are switched on only when the suitcase or bag is picked up, battery life is practically equal to shelf life, hence ensuring high system availability.

### BACKGROUND OF THE INVENTION

This invention relates to a system for baggage weight monitoring and theft protection using transducers such as load cells, strain gages, etc. built into the suitcase or bag. In the weight monitoring mode the system displays the weight of the bag thus facilitating packing. When a preset maximum weight is exceeded, an excess weight monitor signals this audibly and visually. In the theft protection mode, the system triggers an alarm indicating that the suitcase, bag or other baggage has been picked up, thus giving a reliable early warning of possible theft.

### DETAILED DESCRIPTION OF THE INVENTION

PRIOR ART—WEIGHING: The majority of known baggage weighing systems are intended for use by transport facilities such as airport check-in counters and hence are based on external measurement. No specialized equipment is available for use at home or en route, hence travelers often have no opportunity to check for excess weight until the luggage is weighed in at the check-in counter. In the past excess baggage weight was a posed no problem because in general either no charge or only a small charge was made. Today, because of stringent security and weight restrictions, charges for excess weight are relatively high.

Air, train and bus passengers are therefore increasingly being forced to check baggage weight before arriving at the air terminal, train station or bus station. Weighing devices available at home are not suitable for checking large suitcases or bags. In the case of tourists and other passengers with multiple destinations the problem is aggravated by the fact that baggage contents continuously change when objects such as presents are removed and others such as souvenirs are added en route. In these cases there is practically no method available for checking baggage

PRIOR ART—THEFT PROTECTION: All known security devices for baggage theft protection are based on movement of the object from its stationary location. These systems vary in complexity: the simplest use motion or acceleration detection whereas the sophisticated ones use position location based on a GPS receiver (global positioning system). Most of these systems need prior definition of the secure zone and a minimum movement out of this zone.

IMPROVEMENTS—WEIGHING MODE: In the weighing mode, this system is the first to address the problem of avoiding excess weight during the packing process, thus avoiding last-minute unpacking and re-packing for example at the check-in counter.

IMPROVEMENTS—THEFT PROTECTION: The system proposed has three major advantages over prior techniques: It gives an early warning the moment the baggage is picked up, it is simple to implement and because the circuits are only activated when the bag is picked up, battery life is practically equal to its shelf life—over 10 years when the latest lithium ion cells are used.

### DETAILS

Weight of the baggage is determined by fitting suitable transducers, e.g. load cells, to the bottom of the object concerned. Alternatively force transducers, e.g. strain gages, can be built into the handle of the suitcase or bag. After suitable signal processing the transducer output is fed to a display module for weight indication and optional alarm activation.

In the case the transducers are built into the bottom of the baggage, the signal generated can be passed on to the display unit fitted on top either through a wireless link or by a wired connection between the transducer module at the bottom and the display module on top. The advantage of the wired link is that both modules can use a common electric power source; its disadvantage is that the wires have to be embodied in the case, thus necessitating redesign of the bag.

In the case the transducers are fitted in the handle of the suitcase or bag, only the handle and its anchoring have to be redesigned, thus reducing costs.

In the theft protection mode the system is preferably designed so that the alarm signal is relayed to an external device such as a cellular phone. False alarms can be eliminated by using a unique 32-bit identification code for each transmitter-receiver pair. And by employing the internationally allocated 868 MHz frequency band, the transmitter-receiver link can be reliably maintained at ranges of up to 300 m even when using transmitter powers in the 10 mW range.

State of the art semiconductor technology will allow multiple functions to be combined on a single semiconductor chip thus reducing both space and electric energy requirements.

A unique feature of the proposed system is that all circuits are in the “off” state until the bag is picked up, thus ensuring high availability and long operational life.

### BRIEF DESCRIPTION OF THE DRAWINGS

Listing of Figures:

FIG. 1—First embodiment (bottom): Transducer (1), signal processor (2) and transmitter modules (3) built into the bottom of the baggage.

FIG. 2—First embodiment (top): Receiver (4), signal processor (2) and display modules (5) built into the baggage handle.

FIG. 3—Second embodiment: Transducer (1), signal processor (2), transmitter (3) and display modules (5) all built into the baggage handle.

FIG. 4—Alarm processing modules in an external device, e.g. cellular phone: receiver (4), signal processor (2) and alarm processor (6).

FIG. 5—Mechanical layout of modules in the first embodiment: The combined transducer, signal processor and transmitter module (a) is located in the bottom of the baggage (A) and the combined receiver and signal processor (b) as well as the display unit (c) are located in the handle (B).

FIG. 6—Mechanical layout of modules in the second embodiment: All modules are located on top of the bag (A), ideally within the handle (B). Transducer and signal processor are located in the anchoring (a), the transmitter (b) at the bottom of the handle, and the display (c) on top.

FIG. 7—Exemplary combination of a piezoelectric transducer (a), its associated pre-loading bolt (f), and on-off switch (d) in the handle (b). Normally in the off-state, the switch is actuated by the lifting force (e) which is equal to the weight of the bag (A).

### DETAILED DESCRIPTION OF THE INVENTION

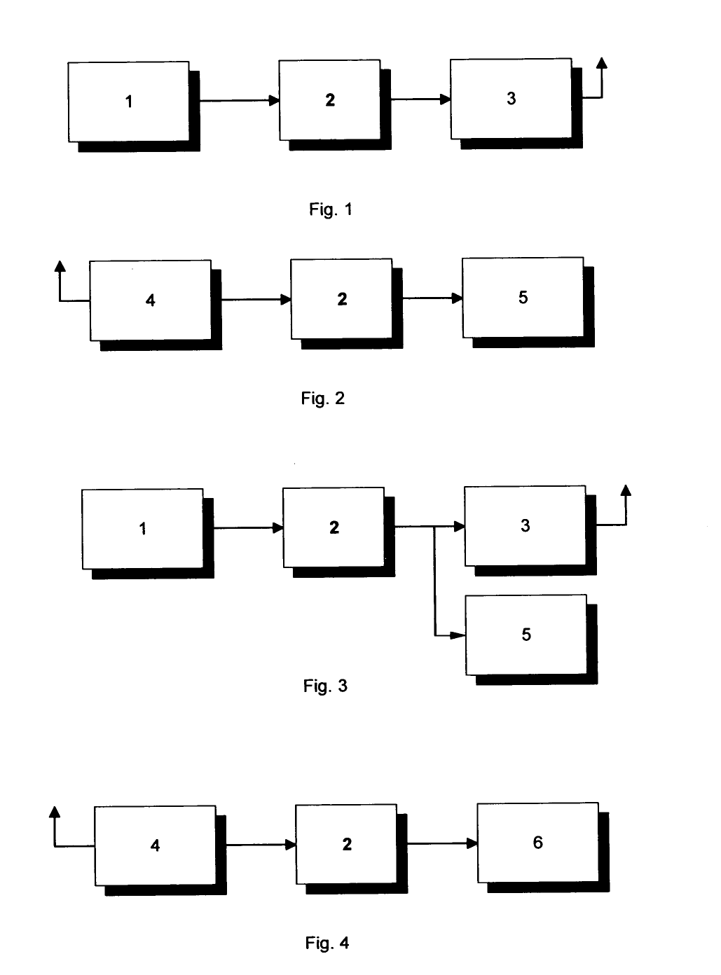

In a first embodiment of the proposed method, schematically shown in FIG. 1, the weight-dependent signal from a load cell or other load transducer (1) is converted to a suitable form by the signal processor (2) before being fed to the transmitter (3).

As shown in FIG. 2, the transmitted signal is picked up by the receiver (4), conditioned by the signal processor (2) and then fed to the display (5).

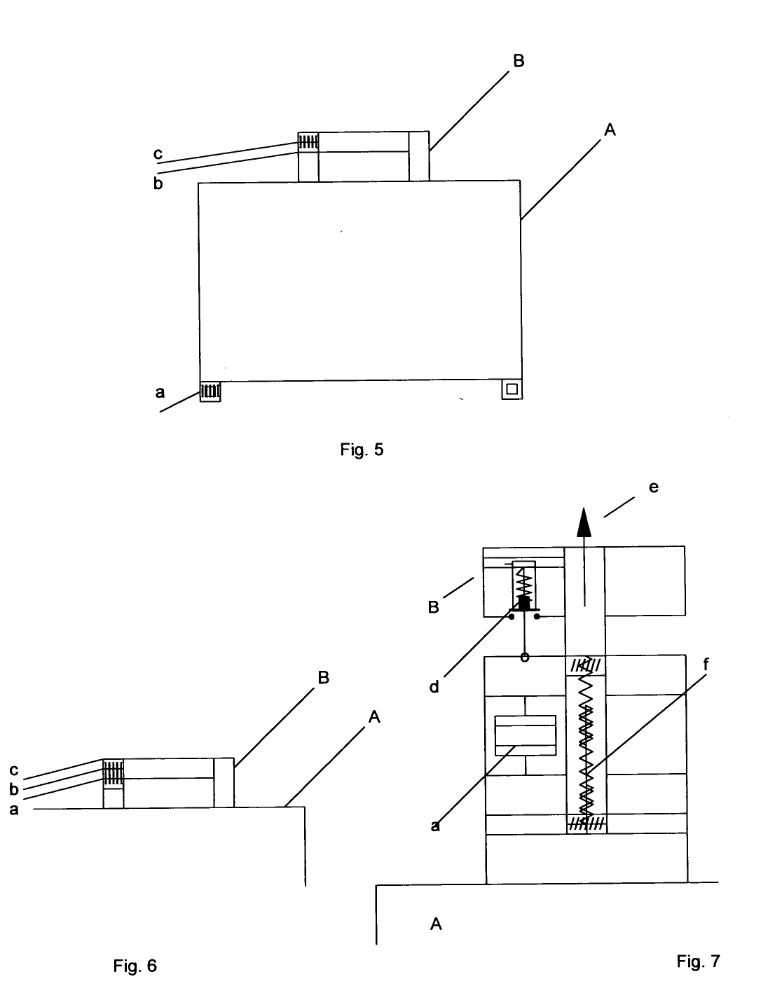

FIG. 5 shows the mechanical layout of the first embodiment. The combined transducer, signal processor and transmitter module (a) is located in the bottom of the baggage (A) and the combined receiver and signal processor (b) as well as the display unit (c) are located in the handle (B). Accurate weight determination would necessitate fitting four modules (a), i.e. one in each of the four baggage corners. However, for the purpose of excess weight determination it is sufficient to measure the load at one corner and multiply this by a calibration constant. For theft protection only one transducer is needed.

In a second embodiment, schematically shown in FIG. 2, the force-dependent signal from a strain gage, capacitive sensor or other force transducer is conditioned by the signal processor (2) before being fed to the transmitter (3) and the display (5).

FIG. 6 shows the mechanical layout of the second embodiment. The transducer (a) is located immediately above the anchoring of the handle. The combined signal processor and transmitter (b) is mounted in the lower part of the handle and the display (c) in the upper part. For accurate weight determination a second transducer would be necessary at the other end of the handle. However, for the purpose of excess weight determination it suffices to measure the force at one end and multiply this by the factor 2. Again for theft protection one transducer is all that is needed.

In both embodiments the system has two modes of operation: In the first mode, “Weight Monitoring”, the display shows the actual weight. When the weight exceeds a preset maximum value, an excess weight alarm is triggered. The alarm can be audible and/or visual. In the second mode, “Theft Protection”, a loud acoustic alarm is triggered the moment the suitcase or bag or other piece of baggage is picked up.

Both embodiments can be extended by installing a suitable receiver module with corresponding alarm signal processing unit in an external device such as a cellular phone. Remote alarm generation is an important additional feature when the system is used in the “Theft Protection” mode.

In contrast to known monitoring systems, the proposed method has a very low power consumption because all modules are normally in the switched off state. They are only activated when the suitcase or bag is picked up. In an exemplary solution using a preloaded piezoelectric transducer (a) as shown in FIG. 7, the lifting force (e) pulls up the handle (B) with respect to the bag (A). thus actuating an on-off switch (d). During packing, the circuits are active only when the weight is checked and during theft monitoring only when a possible thief picks up the bag. Hence the risk of system failure due to exhausted batteries is significantly lower than in all other known systems.

What is claimed is:

1. A method of monitoring baggage weight by using built-in transducers to determine the weight and trigger an audible and/or visual alarm when a preset maximum value is exceeded, thus facilitating packing and eliminating the risk of excess weight charges.

2. A method of theft protection for baggage based on signals from built-in transducers which are generated the moment the baggage's handle is lifted up, thus giving an early warning of possible theft by triggering an alarm fitted to the baggage itself and/or to an external device such as a cellular phone.
